(19) United States
(12) Patent Application Publication
(10) Pub. No.: US 2026/0084243 A1
(43) Pub. Date: Mar. 26, 2026

(54) IMPELLER FOR A FLOW MACHINE AND METHOD FOR PRODUCING AN IMPELLER

(71) Applicant: PILLER BLOWERS & COMPRESSORS GMBH, Moringen (DE)

(72) Inventors: Mansour MHAEDE, Northeim (DE); Hans-Joachim RING, Gieboldehausen (DE); Frank BRÜCKNER, Dresden (DE); Francesco BRUZZO, Dresden (DE)

(21) Appl. No.: 19/109,876

(22) PCT Filed: May 12, 2023
(86) PCT No.: PCT/EP2023/062759

§ 371 Date: Mar. 7, 2025

(30) Foreign Application Priority Data
Sep. 9, 2022 (DE) 10 2022 123 029.5

(51) Int. Cl. B23K 26/342; B23K 101/00; B23K 103/04; B23K 103/14; B33Y 10/00; B33Y 80/00

(52) U.S. Cl. CPC B23K 26/342; B33Y 10/00; B33Y 80/00; B23K 2101/001; B23K 2103/04; B23K 2103/14

(57) ABSTRACT

A method for producing an impeller of a flow machine. The impeller includes a base body, and an impeller blade connected in a material-locking manner. The method includes: processing a blank formed from solid material to generate a first partial section of the base body; applying a material layer to the first partial section for generating a second partial section of the base body, at least in sections, by using an additive manufacture method; and applying a material layer to the first partial section and/or the second partial section for generating an impeller blade on the base body, at least in sections, by using an additive manufacture method.

### DESCRIPTION

The invention relates to a method with the features of independent patent claim 1, an impeller with the features of independent patent claim 17 and a flow machine with the features of independent patent claim 18.

Impellers of flow machines are exposed to high mechanical loads during operation and sometimes have complex geometries in order to achieve the highest possible efficiency and the desired operating behavior. In particular, the geometry of surfaces that interact with the flow during operation can be at least partially the result of fluidic optimization and have a complex configuration. This can, for example, relate to the contouring of the impeller blades arranged on the impeller or the impeller hub or the impeller base body. In some cases, these flow-optimized geometries can only be produced with sufficient precision in the manufacturing processes on which the impellers are based with great effort, which results in correspondingly high manufacturing costs. It is also important to ensure that the connection between the impeller blades and the base body is as strong as possible in order to prevent mechanical failure of the impeller during operation. Reasons for mechanical failure can be, for example, the centrifugal forces of the blades caused by high rotational speeds or the effect of foreign bodies entering the impeller.

One way of producing impellers for flow machinery is to machine a solid material blank, whereby the impeller is produced as a whole from the blank. As the solid material blank must therefore completely cover the later dimensions of the impeller, the amount of material that has to be removed in the course of manufacture is correspondingly large. The time required to remove the material and the large amount of excess material makes time-and cost-efficient manufacture difficult.

It is therefore an object of the present invention to at least partially overcome at least one of the disadvantages described above. In particular, it is the object of the invention to provide a method for manufacturing an impeller of a flow machine, which enables a time-efficient and/or cost-effective and/or material-saving manufacture of a preferably geometrically complex impeller.

The above problem is solved by a method having the features of independent patent claim 1, by an impeller having the features of independent patent claim 17 and by a flow machine having the features of independent patent claim 18. Further features and details of the invention are apparent from the dependent claims, the description and the drawings. Features and details which are described in connection with the method according to the invention naturally also apply in connection with the impeller according to the invention and/or in connection with the flow machine according to the invention and vice versa, so that reference is or can always be made to the individual aspects of the invention with respect to the disclosure.

According to the invention, a method is provided for producing an impeller of a flow machine or for utilisation in a flow machine, comprising a base body and at least one impeller blade, wherein the base body and at least a or the impeller blade are connected in a material-locking manner and wherein at least the following stages/steps are carried out, preferably in the specified sequence:
a) processing of a blank formed from solid material to generate a first partial section of the base body,
b) applying of at least one material layer to the first partial section of the base body for generating a second partial section of the base body, at least in sections, by using an additive manufacture method,
c) applying of at least one material layer to the first partial section and/or the second partial section for generating at least one impeller blade on the base body, at least in sections, by using an additive manufacture method.

In other words, it is envisaged that in a, preferably first, processing stage, a partial section of the base body of the impeller is initially produced from a blank formed from solid material. The geometric dimensions of the first partial section are at least one dimension smaller than the blank or the complete and/or final base body produced in the further course of the method. In particular, the blank can be smaller than the complete and/or final base body produced in the further course of the method, at least with respect to a radial extension. Accordingly, the solid material blank used for this manufacturing stage can be smaller compared to other manufacture methods and the excess material in impeller manufacture can thus be reduced.

In a further, preferably second, processing stage, at least one material layer is applied to the first partial section of the base body to generate a second partial section of the base body, at least in sections and preferably completely. This is done by using an additive manufacture method, preferably for the layer-by-layer and/or precise construction of a desired geometry or the geometry of the second partial section. In this way, the second partial section of the base body can be produced or generated in a particularly material-saving manner. At the same time, the utilisation of an additive manufacture method allows the construction of virtually any complex geometries in a comparatively simple manner. Time-consuming machining operations of workpiece processing, such as complex multi-dimensional motion sequences when milling an impeller geometry from a solid material blank, can be effectively avoided or reduced by using an additive manufacture method. This means that the time and costs required to produce an impeller can be reduced. The utilisation of an additive manufacture method also makes it possible to realize a secure, preferably material-locking, connection between the first and second partial section, which can withstand the high mechanical loads of the impeller during operation. In particular, this stage can involve the application of several, preferably successive, material layers, especially a plurality of layers. Preferably, it is conceivable that the second partial section comprises at least 100, preferably at least 200, particularly preferably at least 500 material layers.

In a further, preferably third, processing stage, at least one material layer is applied to the first partial section of the base body and/or the second partial section of the base body in order to generate at least one impeller blade, in particular all impeller blades, on the base body, at least in sections and in particular completely. This is achieved by using an additive manufacture method, preferably for the layer-by-layer and/or precise construction of a desired geometry or the geometry of at least one impeller blade. In this way, at least one impeller blade, preferably all impeller blades, of the impeller can be produced in a particularly material-saving manner. At the same time, the utilisation of an additive manufacture method allows the construction of virtually any complex geometries, which is particularly advantageous with regard to highly optimized 3D blade contours. Time-consuming machining operations of workpiece processing, such as complex motion sequences when milling an impeller geometry from a solid material blank, can be effectively avoided or reduced. This means that the time and costs required to produce an impeller can be reduced. Also, by utilising an additive manufacture method, a secure, preferably material-locking, connection can be realized between at least one impeller blade and the base body of the impeller or the first and/or second partial section, which can withstand the high mechanical loads of the impeller during operation. In particular, this stage may comprise the application, preferably in succession, of several, in particular a plurality, of material layers. It may be provided that at least one impeller blade comprises at least 50, preferably at least 100, particularly preferably at least 200 material layers. It may further be provided that at least one material layer applied in this stage, in particular all material layers, overlaps both the first partial section and the second partial section.

Applying at least one material layer to the first and/or second partial section of the base body comprises the idea that only a first material layer is applied directly to the first and/or second partial section and at least one subsequent material layer is applied, preferably subsequently, to the respective previously applied material layer and thus only indirectly to the first and/or second partial section of the base body. Also included is the idea that several material layers, for example next to one another, are first applied directly to the first and/or second partial section and only then is at least one subsequent layer applied to at least one previously applied material layer and thus only indirectly to the first and/or second base body. In other words, each, in particular successive, layer build-up in the course of an additive manufacture method is encompassed by the idea of the present invention, in particular at least with respect to the generation of the second partial section of the base body and/or at least one impeller blade or to stages b) and/or c).

Within the scope of the invention, it may be provided that the flow machine is a, preferably continuously operating, flow machine for compressing a fluid flow (compressor). The flow machine can also be a flow machine for at least partial expansion of a fluid flow (turbine). The fluid guided in the flow machine can preferably be a compressible fluid or the flow machine can be configured to guide a compressible fluid. In particular, the fluid can be a gas and/or steam.

The flow machine can have several stages, preferably through which a fluid flow passes or can pass in succession. It may be provided that each stage comprises at least one impeller and/or a guide wheel. Furthermore, the flow machine may comprise at least one shaft, with at least one impeller, preferably all impellers, being connected to the shaft in such a way that the shaft and the impeller can carry out a rotation together. It is also possible for the flow machine to have several shafts and for at least one impeller to be connected to each shaft.

When a flow machine is configured as a compressor, an impeller is used at least to transfer kinetic energy from a shaft to a fluid flow guided in the flow machine. For this purpose, the impeller is set in rotation via the shaft connected to the impeller. The kinetic energy introduced into the flow by the rotation of the impeller and, in particular, by the impeller blades or vanes of the impeller can be at least partially converted into pressure energy in at least one impeller and/or at least one guide wheel through a targeted deflection and deceleration and the fluid flow guided through the flow machine can thus be compressed.

In the configuration of a flow machine as a turbine, an impeller serves at least to extract kinetic energy and/or pressure energy from a fluid flow guided through the flow machine and to transfer it to a shaft connected to the impeller or to set the shaft in rotation as a result. For this purpose, the fluid flow guided in the flow machine is at least partially expanded in at least one impeller and/or at least one guide wheel of the flow machine. The resulting acceleration of the fluid flow and a targeted deflection of the flow onto the impeller or, in particular, the impeller blades of the impeller, generates a torque on the shaft and thus causes the shaft to rotate.

A guide vane of a flow machine is a static component which at least serves to deflect the fluid flow guided in the flow machine in order to enable the best possible flow to the impeller blades of a downstream impeller in the direction of the fluid flow. The blading or the guide vanes of a guide wheel itself can also be configured for at least partial expansion or acceleration (turbine) and/or compression or deceleration (compressor) of the flow

The impeller blades arranged on the base body of the impeller, which serve at least to guide the flow and/or achieve a desired flow deflection in the impeller, are referred to as rotor blades. Depending on the mode of operation of the flow machine (compressor or turbine), a blade passage formed by two impeller blades can be used for at least partial deceleration and/or compression of a fluid flow (compressor) or at least partial expansion and/or acceleration of a fluid flow.

Within the scope of the invention, it may be provided that the impeller is an impeller of radial configuration, in particular a radial compressor impeller or radial turbine impeller, and/or that the impeller is configured such that an inflow of a fluid flow into the impeller takes place along or essentially along an axial direction and/or an outflow of a fluid flow from the impeller takes place along or essentially along a radial direction. Preferably, any circumferential components of the velocity are not to be taken into account in these specifications. The advantages of the method according to the invention are particularly evident in the manufacturing of impellers with a radial configuration. In principle, however, other impeller configurations such as impellers of axial configuration (axial compressor impeller or axial turbine impeller) are also covered by the idea of the invention. This also applies to mixed forms of the aforementioned configurations, in particular for impellers of diagonal compressors.

In the present case, the axial direction is oriented along or parallel to the axis of rotation of the impeller and the radial direction is oriented orthogonally to the axis of rotation of the impeller.

It may be provided that the base body is composed entirely of the first partial section and the second partial section or that the first partial section and the second partial section form the base body entirely. In other words, it may be provided that the base body does not comprise any further partial section in addition to the first partial section and the second partial section.

Within the scope of the invention, it may be provided that the base body is configured to be connected to a shaft, at least in sections. The base body can be configured to be rotationally symmetrical at least in sections, in particular completely or essentially completely. Furthermore, it may be provided that the base body is configured or functions as a carrier element for at least one, in particular all, impeller blades. In other words, it may be provided that the base body is configured without blades or does not comprise any blades, in particular impeller blades. Furthermore, it may be provided that at least one impeller blade of the impeller extends at least in sections over the first and the second partial section.

It is conceivable within the scope of the invention that the first partial section and the second partial section are connected in a material-locking manner at least in sections. Within the scope of the invention, it may also be provided that at least one impeller blade is connected to the base body, in particular to the first partial section and/or the second partial section, at least in sections with a material-locking connection. A particularly simple and at the same time resilient connection between the first and second partial sections or the base body and at least one impeller blade is achieved by a material-locking connection.

Within the scope of the invention, it may be provided that at least two stages of a method according to the invention are carried out simultaneously at least in some sections or overlap in their execution at least in some sections. In particular, this may concern at least stages b) and c). Thus, it is conceivable that while at least one material layer for generating a second partial section of the base body is being applied to the first partial section of the base body, at least one material layer is also already being applied to at least the first partial section of the base body for generating at least one impeller blade. This can speed up the producing method. It is also conceivable that at least one stage, preferably at least stage b) and/or c), is carried out repeatedly in the course of producing an impeller.

In the context of the invention, it may be advantageous for the material layer to be applied in stage b) and/or stage c) by build-up welding, preferably by laser build-up welding, in particular utilising an additive. In laser build-up welding, the surface of a workpiece, in particular the base body, is melted locally by a laser with simultaneous application of an additive to the melted surface. Under the influence of the laser or in the immediate vicinity of the melted workpiece surface, the additive also melts and connects in a material-locking manner with the workpiece. By supplying the additive, a local increase in material can be realized on the workpiece, so that, in particular by repeatedly carrying out this process, the desired geometry can be built up on an existing workpiece (in this case the base body), preferably layer by layer. In other words, a 3D geometry can be built up on the workpiece surface, preferably layer by layer, by arranging several welding tracks or welding beads at least in sections next to each other and/or on top of each other or overlapping on a surface of a workpiece, in particular the first and/or second partial section of the base body.

During laser build-up welding, an additive can preferably be supplied in powder form or as a solid, e.g. as a rod or wire. The additive can comprise the same material as the workpiece to which the additive is applied. In particular, the additive can comprise the same material as the first and/or second partial section of the base body. The build-up welding can be carried out at least partially continuously, in particular along a previously defined contour or a previously defined path, on a workpiece surface or a surface of the first and/or second partial section. By generating a geometry, preferably layer by layer, using an additive manufacture method, in particular by build-up welding, the desired geometry of the base body can be generated reliably and with only little or no excess material.

Within the scope of the invention, it may be provided that an axis of rotation of the first partial section and an axis of rotation of the second partial section are arranged coaxially. In other words, it may be provided that the first partial section and the second partial section are rotationally symmetrical, at least in sections, and that the respective axes of rotation of the first and second partial sections are arranged coaxially

Furthermore, it may be provided in the context of the invention that the second partial section encloses the first partial section at least in sections, in particular completely. In other words, it may be provided that at least in stage b) the material layer applied to the first partial section extends at least in sections over an outer circumference or an outer peripheral surface of the first partial section and thus encloses the first partial section at least in sections.

It is conceivable that the first partial section extends at least between a first inner radius and a first outer radius and that the second partial section extends at least between a second inner radius and a second outer radius, the first outer radius preferably being equal to the second inner radius. Additionally or alternatively, it may be provided that the second partial section is generated on an axially or substantially axially extending outer surface of the first partial section.

Within the scope of the invention, it is conceivable that the first partial section and the second partial section of the base body are formed at least in sections from the same material or uniform material and/or that at least one partial section, in particular the first and/or the second partial section, of the base body and at least one impeller blade are formed at least in sections from the same material or uniform material. This results in a particularly high load-bearing capacity and/or durability of the impeller. Furthermore, a particularly reliable connection between the first and second partial sections and/or at least one impeller blade and the first and/or second partial section is achieved, particularly with regard to production utilising an additive manufacture method, in particular build-up welding.

Within the scope of the invention, it may be provided that at least a partial section of the base body, in particular the first and/or the second partial section, and/or at least one impeller blade are produced or formed at least in sections from a martensitic and/or precipitation-hardened steel. In particular, it may be provided that the impeller is produced or formed entirely from a martensitic and/or precipitation-hardened steel. This results in the advantage of a cost-effective production of the impeller with a high mechanical load capacity at the same time. In addition, such a substance has proven to be positive in terms of its processability with regard to its utilisation in an additive manufacture method, in particular build-up welding.

According to the invention, it is conceivable that the steel contains at least one of the following alloying elements in the specified amount:
10% to 20%, preferably 13% to 18%, particularly preferably 15% to17 % chromium,
1% to 7%, preferably 2% to 6%, particularly preferably 3% to 5% nickel,
1% to 7%, preferably 2% to 6%, particularly preferably 3% to 5% copper.

The percentages specified refer to the mass fraction of the respective alloying element contained in the steel (mass fraction). A steel comprising at least one of the above-mentioned alloying elements in the specified amount indicated has been shown to be particularly advantageous in terms of processability in the context of a method according to the invention and in terms of the load-bearing capacity and durability of the impellers manufactured therefrom. Particularly good results were found with a steel alloy containing all alloying elements in the specified quantities, in particular 15% to 17% chromium, 3% to 5% nickel and 3% to 5% copper.

It is also conceivable that the steel has at least one of the following substance properties:
Tensile strength (Rₘ) of 900 to 1400 N/mm², preferably from 1000 to 1300 N/mm², particularly preferably from 1070 to 1270 N/mm²,
Yield strength (R_{p0,2}) of at least 800 N/mm², preferably of at least 900 N/mm², particularly preferably of at least 1000 N/mm²,
E-modulus of 100 to 300 kN/mm², preferably 150 to 250 kN/mm², particularly preferably 180 to 220 kN/mm², especially 200 kN/mm²,
Elongation at break (A₅) of at least 5%, preferably at least 8%, particularly preferably at least 10%,
Hardness (HB30) from 250 to 450 HB, preferably from 300 to 400 HB, particularly preferably from 330 to 390 HB,
Notched impact strength of at least 10 J, preferably at least 15 J, particularly preferably at least 20 J.

All information on substance properties applies at a temperature of 20° C. (degrees Celsius). A steel that has at least one of the above-mentioned substance properties in the specified range has proven to be particularly advantageous in terms of the mechanical strength of the impellers made from it. This applies in particular to a steel which has all of the above-mentioned substance characteristics in the specified value ranges, especially for a steel with a tensile strength of 1070 N/mm² to 1270 N/mm², a yield strength of at least 1000 N/mm², an E-modulus of 200 N/mm², an elongation at break of at least 10%, a hardness of 330 HB to 390 HB and a notched impact strength of at least 20 J.

Furthermore, it may be provided within the scope of the invention that at least a partial section, in particular the first and/or the second partial section, of the base body and/or at least one impeller blade is produced or formed at least in sections from a titanium substance. It may also be provided that the impeller is produced or formed entirely from a titanium substance. This results in the advantage of a particularly light construction of the impeller with a high mechanical load capacity at the same time. In addition, such a substance has proven to be positive in terms of its processability with regard to its utilisation in an additive manufacture method, in particular build-up welding.

It is conceivable that the titanium substance contains at least one of the following alloying elements in the specified quantity:
3% to 10%, preferably 5% to 8%, particularly preferably 5.5% to 6.75% aluminum,
1% to 7%, preferably 3% to 6%, particularly preferably 3.5% to 4.5% vanadium.

The percentages specified refer to the mass fraction of the respective alloying element contained in the titanium substance (mass fraction). A titanium substance comprising at least one of the above-mentioned alloying elements in the respective specified quantity has been shown to be particularly advantageous in terms of processability in the context of a method according to the invention and in terms of the load-bearing capacity and durability of the impellers manufactured therefrom, while at the same time keeping the weight of the impellers low. Particularly good results were found with a titanium substance containing all alloying elements in the specified quantities, in particular 5.5% to 6.75% aluminum and 3.5% to 4.5% vanadium.

It is also conceivable within the scope of the invention that the titanium substance has at least one of the following substance properties:
Tensile strength (Rₘ) of at least 700 N/mm², preferably of at least 850 N/mm², particularly preferably of at least 895 N/mm²,
Yield strength (R_{p0,2}) of at least 700 N/mm², preferably of at least 800 N/mm², particularly preferably of at least 828 N/mm²,
E-modulus of 80 kN/mm² to 130 kN/mm², preferably from 100 kN/mm² to 120 kN/mm², particularly preferably from 110 kN/mm² to 115 kN/mm², especially from 114 kN/mm²,
Elongation at break (A₅) of at least 5%, preferably at least 8%, particularly preferably at least 10%,
Hardness (HB30) from 200 HB to 350 HB, preferably from 250 HB to 330 HB, particularly preferably from 300 HB to 320 HB,

All information on substance properties applies at a temperature of 20° C. (degrees Celsius). A titanium substance that has at least one of the above-mentioned substance properties in the respective specified range has proven to be particularly advantageous in terms of the mechanical strength of the impellers made from it and the workability of this substance. This applies in particular to a titanium substance which has all of the above-mentioned substance characteristics in the specified value ranges, especially for a titanium substance with a tensile strength of at least 895 N/mm², a yield strength of at least 828 N/mm², an E-modulus of 114 N/mm², an elongation at break of at least 10% and a hardness of 300 HB to 320 HB.

Within the scope of the invention, it may be provided that the method is at least partially automated, in particular by at least one manufacture robot. In particular, it is conceivable that at least stages b) and c) are carried out by a welding robot. It may also be envisaged that at least stage a) or machining of the impeller, in particular of the base body, is carried out by an at least partially automated lathe and/or milling machine.

Furthermore, it may be provided that a CAD model of the impeller geometry serves as the basis for at least one stage of the method. In other words, it may be provided that, in particular before stage a), control commands for at least one manufacturing robot are defined on the basis of a CAD model of the impeller, for at least partial execution of at least one stage of the method according to the invention. Thus, on the basis of the CAD model, at least one movement sequence and/or at least one associated movement speed of at least one processing head of at least one manufacturing robot can be defined in order to manufacture or realize the desired impeller geometry at least in sections.

Within the scope of the invention, it is optionally possible that in addition, preferably after stage b), at least the following stages are carried out:
processing of the first and/or second partial section (11.1, 11.2) at least in sections, preferably by using a machining manufacture method, to produce a continuous surface profile over the first and second partial sections (11.1, 11.2) at least in sections.

In this context, it may be provided that the processing of the first and second partial sections is carried out by turning, with the turning preferably involving the finishing of at least one surface of the base body in order to produce a continuous surface profile, at least in sections, over the first and second partial sections. This improves the surface quality of the base body, at least in sections, in order to reduce flow losses during operation of the impeller. This also allows the base body to be optimally prepared for the subsequent generation of at least one impeller blade and the desired final geometry of the first and second partial sections to be produced with high precision or with low tolerances. Accordingly, this processing stage can preferably be carried out at least on the section or surface of the base body, in particular of the first and/or second partial section, on which at least one impeller blade is generated in stage c).

Furthermore, it may be provided within the scope of the invention that in addition, preferably after stage c), at least the following stages are carried out:
carrying out at least one heat treatment to improve the mechanical properties of the impeller,
processing of at least sections of the first partial section and/or the second partial section and/or at least one impeller blade, preferably by using a machining manufacture method, at least for removing redundant material and/or producing a required surface quality,
balancing the impeller,
clean the impeller, preferably by blast cleaning.

With regard to carrying out a heat treatment, in particular in the case of an impeller which is produced at least in sections or entirely from a steel, it may be provided that the impeller is heated at least temporarily to a temperature of at least 400° C., preferably at least 500° C., particularly preferably to a temperature of at least 550° C. or exactly or substantially exactly 550° C. It may also be provided that the period of time during which the impeller is kept at an elevated temperature is at least 2 hours, preferably at least 3 hours, particularly preferably at least 4 hours or 4 hours. In this way, a particularly advantageous precipitation hardening of the steel substance and a high mechanical load capacity of the impeller could be achieved. A heat treatment comprising heating the impeller to exactly or essentially exactly 550° C. and maintaining this impeller temperature over a period of 5 hours proved to be particularly advantageous. The impeller can then be cooled down to room temperature.

With regard to carrying out a heat treatment, in particular in the case of an impeller which is produced at least in sections or entirely from a titanium substance, it may be provided that the impeller is at least temporarily heated to a temperature of at least 450° C., preferably at least 550° C., particularly preferably to a temperature of at least 600° C. or exactly or substantially exactly 600° C. It may also be provided that the period of time during which the impeller is kept at an elevated temperature is at least 1 hour, preferably at least 1.5 hours, particularly preferably at least 2 hours or 2 hours. In this way, a particularly high mechanical load capacity of the impeller could be achieved. A heat treatment comprising heating the impeller to exactly or essentially exactly 600° C. and maintaining this impeller temperature over a period of 2 hours proved to be particularly advantageous. The impeller can then be cooled down to room temperature. The cooling of the impeller may comprise cooling the impeller to at least one intermediate temperature and holding the impeller at this intermediate temperature at least temporarily. It may be provided that the holding of the impeller at an intermediate temperature is carried out for a period of time of at least 0.5 hours, preferably at least 1 hour or at least 2 hours. Preferably, an intermediate temperature can be 200° C. This has the advantage of further improving the mechanical properties of the impeller

The specification essentially refers to tolerances to be taken into account, which may arise as a result of manufacture or processes. For example, heating in an oven can lead to slight temporal and/or local temperature fluctuations. The geometry of a workpiece is also always subject to manufacture-related inaccuracies (tolerances), the magnitude of which depends on the methods and/or tools and/or machines used.

The heat treatment of the impeller, in particular in the case of an impeller which is produced at least in section or completely from a titanium substance, can be carried out at least partially in a vacuum. It is conceivable that the heat treatment of the impeller is or can be carried out at least partially in a vacuum furnace. In particular, this can prevent oxidation of the impeller during heat treatment and the resulting disadvantages with regard to the mechanical properties of the impeller.

With regard to at least sectional processing of the first partial section and/or the second partial section and/or at least one impeller blade, at least for removing redundant material and/or producing a required surface quality, there is the advantage of a particularly lightweight configuration of the impeller and/or a high surface quality to avoid flow losses. The processing can preferably be carried out by turning and/or milling.

With regard to at least sectional processing of the first partial section and/or the second partial section, at least for removing redundant material and/or producing a required surface quality, it can be provided that this is carried out at least on a surface of the base body or of the first and/or second partial section without blades. In other words, the processing can take place at least on a surface of the base body or of the first and/or second partial section on which no impeller blade is arranged and/or is opposite the surface on which at least one impeller blade, preferably all impeller blades, is arranged. The processing can be a final processing or serve to generate the final base body geometry.

With regard to balancing the impeller, it can be provided that at least one balancing weight is arranged on the impeller to compensate for an imbalance. Preferably, the balancing weight can be welded on. In addition or alternatively, material can be removed from at least one position on the impeller, preferably utilising a machining manufacture method such as drilling or milling, in order to compensate for an imbalance on the impeller. It may also be provided that during balancing, the impeller is accelerated at least once to a rotational speed of 1000 revolutions per minute and then braked again, in particular to a rotational speed of 0 revolutions per minute.

With regard to cleaning the impeller by cleaning blasting, it may be provided that a spherical or grain-shaped blasting medium is used. In particular, a cast stainless steel blasting medium can be used as the blasting medium or the blasting medium can be at least partially, in particular completely, produced of stainless steel. It may be provided that the blasting medium has a diameter or grain size of between 0.05 mm and 0.6 mm, in particular between 0.09 mm and 0.5 mm. Particularly preferably, the abrasive may have a diameter or grain size of between 0.05 mm and 0.315 mm or between 0.14 mm and 0.5 mm. The utilisation of an abrasive according to the above specifications has shown the advantage of a particularly high degree of cleaning and a particularly high surface quality of the impeller.

In relation to the present invention, it is conceivable that at least the processing in stage a) is carried out by using at least one machining manufacture method, preferably by turning and/or milling. The processing can be at least partially automated, whereby the tolerances with respect to the impeller geometry can be reduced.

It may be provided within the scope of the invention that in addition, preferably before stage a) and/or before stage b) and/or before stage c), at least the following stage is carried out:
inserting of the blank formed from solid material and/or the first and/or second partial section into the interior of a processing chamber,
closing the processing chamber,
producing an inert gas atmosphere in the interior of the processing chamber, wherein in particular the oxygen content in the inert gas atmosphere is 100 ppm or less and/or the water content in the inert gas atmosphere is 100 ppm or less,
opening of the processing chamber and removal of the base body or at least a partial section of the base body and/or the impeller.

It may be envisaged that the blank is first introduced into the processing chamber and this is closed and then the inert gas atmosphere is produced in the processing chamber. Alternatively, it is conceivable that an inert gas atmosphere is first produced in the processing chamber and the blank is then introduced into the processing chamber, in particular via an airlock. Furthermore, the processing chamber can be closed in such a way that an exchange of atmosphere between the interior of the processing chamber and the external environment of the processing chamber is prevented or essentially prevented, in particular as long as the processing chamber is closed.

It is conceivable within the scope of the invention that at least one stage of the method according to the invention takes place in an inert gas atmosphere. In other words, it may be envisaged that the production of the impeller takes place at least partially while the impeller is surrounded, preferably completely or substantially completely, by an inert gas. Preferably, helium or argon can be used as the inert gas. The utilisation of further (different) inert gases or a mixture of at least two inert gases is also covered by the idea of the invention. By processing the impeller blank or the base body in an inert gas atmosphere, oxidation of the workpiece surface can be effectively avoided. Processing under an inert gas atmosphere has proven to be particularly advantageous when utilising a titanium substance. It may be provided that the oxygen content in the inert gas atmosphere is 100 ppm (parts per million) or less, in particular 80 ppm or less, preferably 50 ppm or less. In particular, an oxygen content of 50 ppm or less has proven to be advantageous in terms of effectively preventing oxidation. It is also conceivable that the water content (H₂O) in the inert gas atmosphere is 100 ppm or less, in particular 80 ppm or less, preferably 50 ppm or less. In particular, a water content of 50 ppm or less has proven to be particularly advantageous in the context of a manufacture method according to the invention with regard to the manufacture of high-quality workpieces.

It may further be provided that at least one stage of the method is carried out in the interior of a processing chamber, in particular the interior of the processing chamber being hermetically sealed or substantially hermetically sealed with respect to the external environment of the processing chamber and/or filled or substantially filled with an inert gas at least during the execution of at least one method stage. In other words, it may be provided that at least one method stage is not carried out in the processing chamber until an inert gas atmosphere has been produced in the processing chamber. This can be achieved by evacuating the processing chamber, in particular utilising a vacuum pump, and then filling the processing chamber with an inert gas. The processing chamber can also or alternatively be flushed with an inert gas until the desired inert gas atmosphere is produced. The processing chamber can be hermetically sealed from the external environment of the processing chamber so that no or essentially no exchange of atmosphere takes place between the interior of the processing chamber and the external environment of the processing chamber as long as the processing chamber is hermetically sealed. The processing chamber can comprise at least one oxygen sensor with which an oxygen concentration in the processing space of the processing chamber can be detected.

Within the scope of the invention, it may be provided that all method stages or only individual method stages are carried out in the processing chamber. It may also be provided that the workpiece (the impeller) is removed from the processing chamber between individual method stages and is reintroduced into the processing chamber before a subsequent method stage, or that the workpiece remains in the processing chamber for several successively executed method stages. With regard to stage a), a blank formed from solid material can be introduced into the processing chamber before stage a) and the first partial section of the base body can be removed from the processing chamber after stage a). With regard to stage b), the first partial section of the base body can be introduced into the processing chamber before stage b) and the base body comprising the first and second partial sections can be removed after stage b). With respect to stage c), the base body can be introduced into the processing chamber before stage c) and the impeller comprising the base body and at least one impeller blade can be removed after stage c).

Furthermore, it may be provided within the scope of the invention that the impeller, preferably after completion of the method according to the invention, has a diameter of at least 400 mm, in particular at least 450 mm, preferably at least 500 mm, particularly preferably at least 560 mm or exactly or substantially exactly 560 mm. In relation to impellers with the above-mentioned diameter, the producing method according to the invention has been shown to be particularly effective. This applies in particular to impellers with a diameter of exactly or substantially exactly 560 mm.

It is also conceivable that the impeller, preferably after completion of the method according to the invention, has an axial extension, in particular along an axial direction, of at least 150 mm, in particular at least 170 mm, preferably at least 180 mm, particularly preferably at least 190 mm or exactly or substantially exactly 190.4 mm. In relation to impellers with the above-mentioned axial extension, the production method according to the invention has been shown to be particularly effective. This applies in particular to impellers with an axial extension of exactly or substantially exactly 190.4 mm.

Within the scope of the invention, it may be provided that at least one impeller blade has a greater material thickness on the side facing the base body than on the opposite side or the side facing away from the base body. In other words, at least one impeller blade can have a greater material thickness in the vicinity of the base body or at its blade root than at its blade tip. By increasing the material thickness in the area of the blade root, a more resilient connection of the impeller blade to the base body can be achieved and failure of the impeller blade during operation of the impeller can be avoided. The material thickness can then be successively reduced from the base body or blade root to the intended material thickness of the impeller blade. In particular, it is conceivable that at least one impeller blade has twice as much material thickness on its side facing away from the base body or the blade tip as on its side facing the base body or its blade root.

It may further be provided within the scope of the invention that stage c) is carried out several times and at least one material layer of at least one impeller blade has a smaller layer width than the previously applied material layer of the same impeller blade. The layer width determines the material thickness of the impeller blade in the section of the impeller blade formed by the material layer. Thus, the material thickness of the impeller blade can be specifically varied by varying the layer width of the applied material layers at least in sections, e.g. in order to increase the mechanical load-bearing capacity of the impeller blade in the area of the blade root or on the side facing the base body. In other words, it can thus be provided that at least one impeller blade has a material thickness that varies at least in sections, preferably decreasing at least in sections, along its extension starting from the base body or its blade root in the direction of its blade tip, the material thickness at the blade root preferably being higher than at the blade tip.

The above object is further solved by an impeller according to the invention comprising a base body and at least one impeller blade, the impeller being produced according to a method according to the invention or being produced according to a method according to one of claims 1 to 16. With respect to an impeller according to the invention, the same advantages arise as those explained with respect to the method according to the invention.

The above problem is further solved by a flow machine according to the invention comprising at least one impeller according to claim 17. The same advantages arise in relation to the flow machine as have been explained in relation to the impeller.

Further advantages, features and details of the invention are shown in the following description, in which several embodiments of the invention are described in detail with reference to the drawings. The features mentioned in the claims and in the description may be essential to the invention individually or in any combination. It shows:

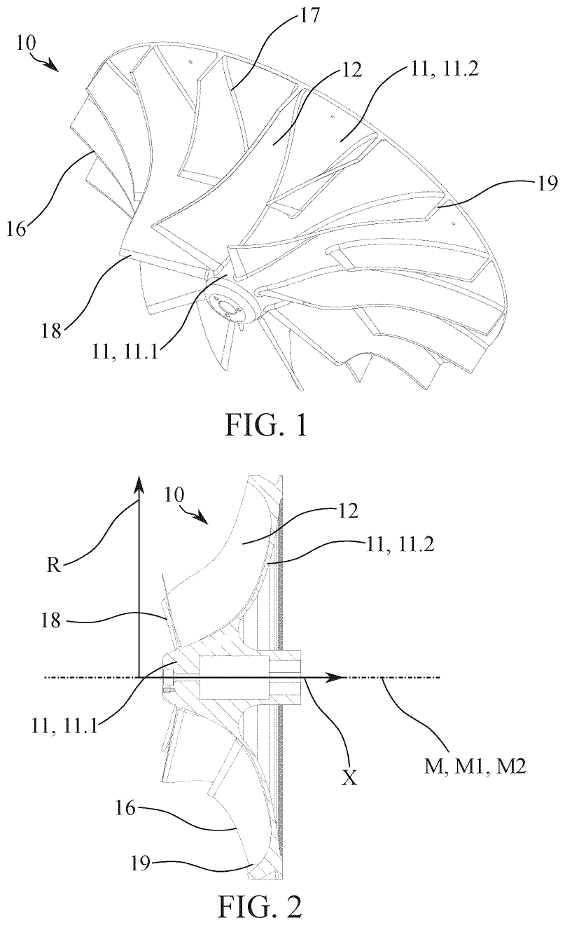

FIG. 1 a perspective view of an impeller according to the invention,

FIG. 2 a sectional view of an impeller according to the invention,

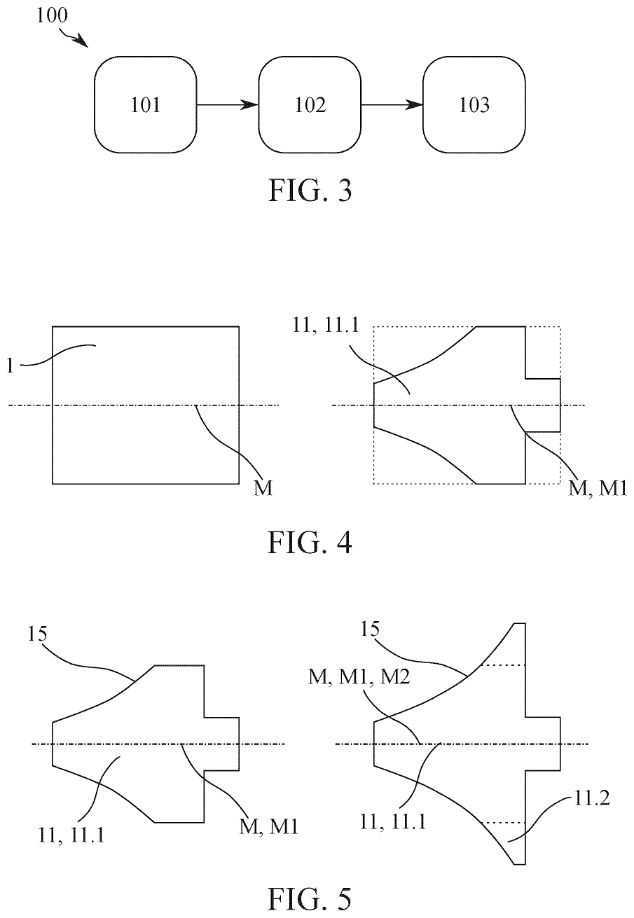

FIG. 3 a schematic representation of a method according to the invention,

FIG. 4 a schematic representation of processing according to stage a),

FIG. 5 a schematic representation of processing according to stage b),

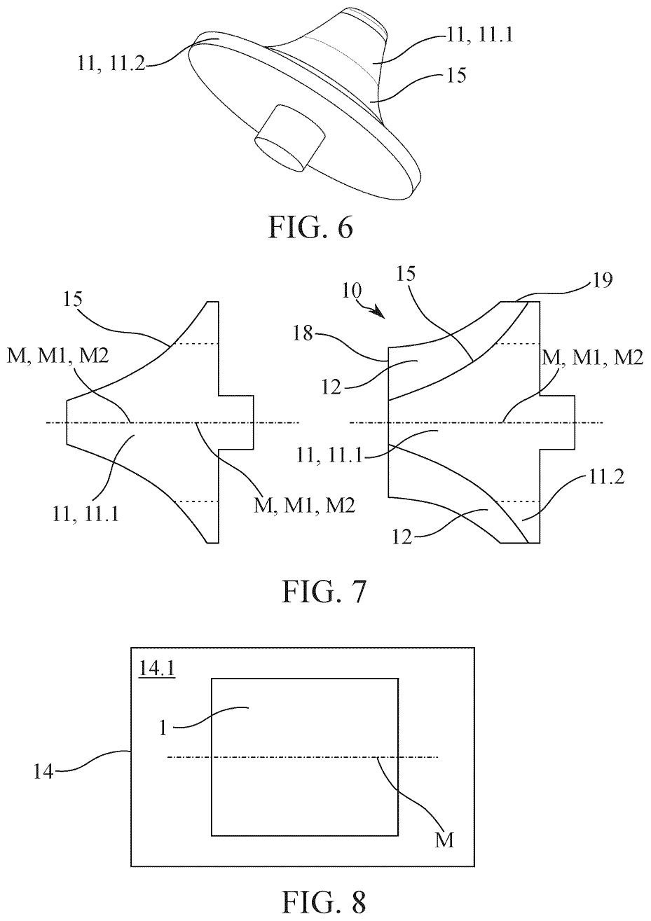

FIG. 6 a perspective view of a base body of an impeller according to the invention,

FIG. 7 a schematic representation of processing according to stage c),

FIG. 8 a blank comprising solid material in a processing chamber and

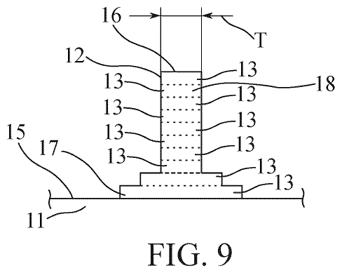

FIG. 9 a schematic structure of an impeller blade.

FIG. 1 shows a perspective view of an impeller 10 according to the invention for utilisation in a flow machine. The impeller 10 is a radial type impeller 10 and is configured as a radial compressor impeller. The impeller 10 comprises a base body 11 and at least one plurality of impeller blades 12. The base body 11 further comprises a first partial section 11.1 and a second partial section 11.2, which are described in more detail below. The impeller blades 12 are arranged on the base body 11 of the impeller 10 and are connected to the base body 11 in a material-locking manner. The first partial section 11.1 and the second partial section 11.2 are also connected in a material-locking manner. Furthermore, the first partial section 11.1, the second partial section 11.2 and the impeller blades 12 of the impeller 10 comprise the same material or are of the same material. The flow through the impeller 10 takes place along the impeller blades 12 from the leading edge 18 in the direction of the trailing edge 19.

FIG. 2 shows a sectional view of an impeller 10 according to the invention, wherein the sectional plane intersects the axis of rotation or center axis of the impeller 10. The impeller 10 is configured in such a way that a flow of fluid into the impeller 10 takes place or can take place along an axial direction X and a flow of fluid out of the impeller 10 takes place or can take place along a radial direction R. The axial direction X is oriented parallel to the axis of rotation M of the impeller 10 and the radial direction R is oriented orthogonally to the axis of rotation M of the impeller 10. The axis of rotation M is arranged coaxially with the axis of rotation M1 of the first partial section 11.1 and with the axis of rotation M2 of the second partial section 11.2. FIG. 3 shows a schematic representation of a method 100 according to the invention for producing an impeller 10 of a flow machine or for utilisation in a flow machine, comprising a base body 11 and at least one impeller blade 12, wherein the base body 11 and the impeller blade 12 are connected in a material-locking manner and wherein at least the following stages are carried out, preferably in the sequence specified:
a) processing a blank 1 comprising solid material to generate a first partial section 11.1 of the base body 11,
b) applying of at least one material layer 13 to the first partial section 11.1 of the base body 11 for generating a second partial section 11.2 of the base body 11, at least in sections, by using an additive manufacture method,
c) applying of at least one material layer 13 to the first partial section 11.1 and/or the second partial section 11.2 for generating at least one impeller blade 12 on the base body 11, at least in sections, by using an additive manufacture method.

The method 100 is explained in more detail below. FIG. 4 schematically shows a processing of a blank 1 according to stage a) in accordance with the invention. The blank 1 is shown on the left-hand side and comprises solid material. The blank 1 is machined in stage a), preferably using a machining manufacture method, so that the first partial section 11.1 of the base body 11 shown on the right-hand side of FIG. 4 is generated from the blank 1. The first partial section 11.1 of the base body 11 is rotationally symmetrical. The areas in which material was removed from the blank 1 in order to generate the geometry of the first partial section 11.1 are marked by dashed lines in the illustration of the first partial section 11.1 in FIG. 4 for the purpose of clarity.

FIG. 5 schematically shows a processing of the base body 11 or of the first partial section 11.1 of the base body 11 according to stage b) in accordance with the invention. On the left-hand side of FIG. 5, the first partial section 11.1 of the base body 11 is shown after the processing carried out in stage a). On the right-hand side, the base body comprising a first partial section 11.1 and a second partial section 11.2 is shown after the processing in stage b). In stage b), a plurality of material layers 13 are applied 102 to the first partial section 11.1 of the base body 11 in order to generate or build up a second partial section 11.2 of the base body 11, in particular layer by layer. This is done by using an additive manufacture method to successively build up the second partial section 11.2 starting from the surface of the first partial section 11.1. The first partial section 11.1 and the second partial section 11.2 form at least one common surface 15 of the base body 11, on which at least one impeller blade 12 can subsequently be generated or is generated.

In the present case, the second partial section 11.2 is generated by laser build-up welding and thus by a material build-up on the first partial section 11.1, whereby the second partial section 11.2 is generated by successive application 102 of several material layers 13 or welding tracks. This results in a material-locking connection between the first partial section 11.1 and the second partial section 11.2.

The additive used to generate the second partial section 11.2 as part of the build-up welding process is formed in the same material as the solid material blank 1 or the first partial section 11.1 of the base body 11. Thus, the first partial section 11.1 and the second partial section 11.2 of the base body 11 are of the same material.

FIG. 5 shows that the second partial section 11.2 completely encloses the first partial section 11.1. The second partial section 11.2 is rotationally symmetrical and the axis of rotation or center axis M2 of the second partial section 11.2 is arranged coaxially with the axis of rotation or center axis M1 of the first partial section 11.1.

Based on FIG. 5, the first partial section 11.1 and the second partial section 11.2 can be processed at least in sections in order to ensure a continuous surface profile and/or a high surface quality of the surface 15.

FIG. 6 shows a perspective view of the base body 11 comprising a first partial section 11.1 and a second partial section 11.2 for clarification. The first partial section 11.1 and the second partial section 11.2 are completely build form the base body 11. Based on the base body geometry shown in FIG. 6, one or more impeller blades 12 can now be generated on the surface 15 of the base body 11.

FIG. 7 schematically shows a processing of the base body 11 or the first partial section 11.1 and the second partial section 11.2 of the base body 11 according to stage c). On the left-hand side of FIG. 7, the base body 11 is shown after the processing carried out in stage b). On the right-hand side, the impeller 10, comprising a base body 11 with a first partial section 11.1 and a second partial section 11.2 as well as at least one impeller blade 12 after the processing in stage c) is shown. In stage c), a plurality of material layers 13 are applied 103 to the first partial section 11.1 and the second partial section 11.2 of the base body 11 in order to generate or build up at least one impeller blade 12, in particular a plurality of impeller blades 12, on the base body 11, preferably layer by layer. This is done by using an additive manufacture method to successively build up at least one impeller blade 12 starting from the surface 15 of the base body 11. At least one impeller blade 12 extends at least in sections over the first partial section 11.1 and the second partial section 11.2 of the base body.

In the present case, at least one impeller blade 12 is generated by laser build-up welding and thus by a material build-up on the surface 15 of the base body 11 formed by the first partial section 11.1 and the second partial section 11.2, whereby the impeller blade 12 is generated by successive application 103 of several material layers 13 or welding tracks. This results in a material-locking connection between the base body 11 and at least one impeller blade 12, in particular all impeller blades 12. The impeller blades 12 are only shown schematically and geometrically simplified in FIG. 7.

The additive used to generate the second partial section 11.2 as part of the build-up welding process is formed of the same material as the first partial section 11.1 and the second partial section 11.2 of the base body 11. Thus, the first partial section 11.1 and the second partial section 11.2 and the impeller blades 12 of the base body 11 are of the same material.

Based on FIG. 7, further processing stages can be carried out on the impeller 10. For example, at least one at least sectional processing of the first partial section 11.1 and/or the second partial section 11.2 and/or at least one impeller blade 12 can be carried out in order to remove redundant material. Heat treatment of the impeller 10 can also be carried out, balancing of the impeller 10 can be carried out and/or cleaning of the impeller 10 can be carried out

FIG. 8 schematically shows a blank 1 comprising solid material in the interior 14.1 of a processing chamber 14, so that at least stage a), but in particular also at least stages b) and c), can be carried out in the processing chamber 14. The interior 14.1 can be hermetically sealed from the external environment of the processing chamber 14 or is hermetically sealed when at least one processing stage is carried out. In this way, at least one method stage can be carried out under an inert gas atmosphere, which was previously produced by evacuating the interior 14.1 or filling the interior 14.1 with an inert gas. By processing the impeller blank or the base body 11 in an inert gas atmosphere, oxidation of the workpiece surface can be effectively avoided.

FIG. 9 shows a highly simplified view of an impeller blade 12 on the surface 15 of the base body, with the viewing direction along the center axis M directed towards the leading edge 18. The illustration shown in FIG. 9 is only intended to clarify the layered structure of an impeller blade 12. The impeller blade 12 comprises several material layers 13 which have been successively applied to the surface 15 or to the respective preceding material layer 13 using an additive manufacture method. By applying each material layer 13, an increase in material is realized on the impeller blade 12 or on the base body 11, whereby the geometry of the impeller blade 12 can be generated reliably and in a material-saving manner.

The impeller blade 12 has a higher material thickness T on the side facing the base body 11 or on the blade root 17 than on the side facing away from the base body 11 or on the blade tip 16. By increasing the material thickness in the area of the blade root 17, a more resilient connection of the impeller blade 12 to the base body 11 can be achieved and failure of the impeller blade 12 during operation of the impeller 10 can be avoided.

The higher material thickness in the area of the blade root 17 was realized by first applying one or more material layers 13 with a first layer width T in stage c) and subsequently applying at least one material layer 13 with a second layer width T, the second layer width T being smaller than the first layer width T. By changing the layer width T of the material layers 13 applied to the base body 11, the material thickness T of the impeller blade 12 can be varied starting from the base body 11 along the extension of the impeller blade 12 between the blade root 17 and the blade tip 16.

### LIST OF REFERENCE SYMBOLS

1 Blank
10 Impeller
11 Base body
11.1 First partial section
11.2 Second partial section
12 Impeller blade
13 Material layer
14 Processing chamber
14.1 Interior
15 Surface
16 Blade tip
17 Blade root
18 Leading edge
19 Trailing edge
100 Method
101 Processing
102 Application
103 Application
M Center axis/rotation axis
M1 Center axis/rotation axis
M2 Center axis/rotation axis
R Radial direction
T Material thickness/layer width
X Axial direction

1.-18. (canceled)

19. A method for producing an impeller of a flow machine, comprising a base body and at least one impeller blade, wherein the base body and the impeller blade are connected in a material-locking manner, the method comprising:
a) processing a blank formed from solid material to generate a first partial section of the base body,
b) applying at least one material layer to the first partial section of the base body for generating a second partial section of the base body, at least in sections, by using an additive manufacture method, and
c) applying at least one material layer to at least the first partial section or the second partial section for generating at least one impeller blade on the base body, at least in sections, by using an additive manufacture method.

20. The method according to claim 19, wherein
application of the material layer in at least stage b) or c) is performed by build-up welding.

21. The method according to claim 19, wherein
an axis of rotation of the first partial section and an axis of rotation of the second partial section are arranged coaxially or wherein the second partial section encloses the first partial section at least in sections.

22. The method according to claim 19, wherein
the first partial section and the second partial section of the base body are formed at least in sections from the same material or wherein at least one partial section of the base body and at least one impeller blade are formed at least in sections from the same material.

23. The method according to claim 19, wherein
at least one partial section of the base body or wherein at least one impeller blade are formed at least in sections from a martensitic, precipitation-hardened steel.

24. The method according to claim 23, wherein
the steel contains at least one alloying element selected from the group comprising: 10% to 20% chromium, 1% to 7% nickel, and 1% to 7% copper.

25. The method according to claim 23, wherein
the steel has at least one substance property selected from the group comprising: tensile strength (Rₘ) of 900 N/mm² to 1400 N/mm², yield strength (R_{p0,2}) of at least 800 N/mm², E-modulus of 100 to 300 kN/mm², elongation at break (A₅) of at least 5%, hardness (HB30) from 250 HB to 450 HB, and notched impact strength of at least 10 J.

26. The method according to claim 19, wherein
at least one partial section of the base body or wherein at least one impeller blade is produced at least in sections from a titanium substance.

27. The method according to claim 26, wherein
the titanium substance contains at least one alloying element selected from the group comprising: 3% to 10% aluminum and 1% to 7% vanadium.

28. The method according to claim 26, wherein
the titanium substance has at least one substance property selected from the group comprising: tensile strength (Rₘ) of at least 700 N/mm², yield strength (R_{p0,2}) of at least 700 N/mm², E-modulus of 80 kN/mm² to 130 kN/mm², elongation at break (A₅) of at least 5% and hardness (HB30) from 200 HB to 350 HB.

29. The method according to claim 19, further comprising
processing of at least the first or second partial section at least in sections, at least to produce at least i) a continuous surface profile at least in sections over the first and second partial sections or ii) a required surface quality.

30. The method according to claim 19, further comprising
performing at least one heat treatment to improve mechanical properties of the impeller,
processing, at least in sections, at least i) the first partial section or ii) the second partial section or iii) at least one impeller blade, at least for a) removing redundant material or b) producing a required surface quality, balancing the impeller, and cleaning the impeller.

31. The method according to claim 19, wherein
at least the processing a) is performed by at least a machining manufacture method.

32. The method according to claim 19, further comprising:
inserting i) the blank formed from at least the solid material or ii) the first partial section or iii) the second partial section into an interior of a processing chamber, and producing an inert gas atmosphere in the interior of the processing chamber.

33. The method according to claim 19, wherein
the impeller has at least i) a diameter of at least 400 mm or ii) an axial extension of at least 150 mm.

34. The method according to claim 19, wherein
the applying in c) is performed several times and at least one material layer of at least one impeller blade has a smaller layer width than a previously applied material layer of a same impeller blade.

35. The method according to claim 19, wherein a), b) and c) are performed in sequence.

36. The method according to claim 20, wherein the build-up welding is a laser build-up welding.

37. An impeller comprising a base body and at least one impeller blade, the impeller being produced with the method according to claim 19.

38. A flow machine comprising at least one impeller according to claim 37.
